(19) United States
(12) Patent Application Publication
(10) Pub. No.: US 2026/0169291 A1
(43) Pub. Date: Jun. 18, 2026

(54) OPTICAL MODULE AND HEAD-MOUNTED DISPLAY DEVICE

(71) Applicant: Goertek Optical Technology Co., Ltd., Shandong (CN)

(72) Inventor: Wenbao Song, Shandong (CN)

(73) Assignee: Goertek Optical Technology Co., Ltd., Shandong (CN)

(21) Appl. No.: 18/880,050

(22) PCT Filed: Feb. 23, 2023
(86) PCT No.: PCT/CN2023/077853

§ 371 Date: Aug. 13, 2025

(30) Foreign Application Priority Data
Jun. 30, 2022 (CN) 202210768816.3

(51) Int. Cl. G02B 27/01; G02B 27/14; G02B 27/28

(52) U.S. Cl. CPC G02B 27/0172; G02B 27/144; G02B 27/286

(57) ABSTRACT

The present disclosure provides an optical module and a head mounted display. The optical module includes a first lens and a second lens sequentially along an optical axis direction, an edge thickness of an air gap between the first lens and the second lens being L₁, which satisfies: 2 mm<L₁<7 mm; the optical module further includes a polarizing reflective element, a first phase retarder, and a beam splitting element, wherein the polarizing reflective element is located on a side of the first lens, the beam splitting element is located on a side of the second lens, and the first phase retarder is located between the polarizing reflective element and the beam splitting element.

### CROSS-REFERENCE TO RELATED APPLICATIONS

The present disclosure is a National Stage of International Application No. PCT/CN2023/077853, filed on Feb. 23, 2023, which claims priority to Chinese Patent Application No. 202210768816.3, filed on Jun. 30, 2022, both of which are hereby incorporated by reference in their entireties.

### TECHNICAL FIELD

The present disclosure relates to the technical field of optical display, and particularly to an optical module and a head mounted display.

### BACKGROUND

Compared with traditional aspheric and Fresnel VR optical structures, the VR optical structure in the form of folded optical path, due to its advantage of a reduced total length of the optical module, facilitates the miniaturization trend of VR optical modules. However, the existing design of the folded optical path predominantly focuses on minimizing the number of lenses and adjusting the lens thicknesses to reduce the weight of the entire optical module, which may compromise the imaging quality of the optical module.

### SUMMARY

An objective of the present disclosure is to provide new technical solutions for an optical module and a head mounted display, which can reduce the weight and volume of the optical module.

According to an aspect of the present disclosure, an optical module is provided, which includes a first lens and a second lens sequentially along an optical axis direction, and an edge thickness of an air gap between the first lens and the second lens is L₁, which satisfies: 2 mm<L₁<7 mm;
the optical module further includes a polarizing reflective element, a first phase retarder, and a beam splitting element, wherein the polarizing reflective element is located on either side of the first lens, the beam splitting element is located on either side of the second lens, and the first phase retarder is located between the polarizing reflective element and the beam splitting element.

Optionally, the first lens includes a first surface and a second surface, the second lens includes a third surface and a fourth surface, wherein the second surface and the third surface are adjacent and spaced apart;
the edge thickness L₁ of the air gap between the first lens and the second lens is a distance along the optical axis direction between a point A on the second surface and a point B on the third surface, wherein the point A is an incident point at which an upper marginal ray in incident light at the maximum field angle of the optical module is incident on the second surface for the first time, and the point B is an incident point at which the upper marginal ray is incident on the third surface for the second time.

Optionally, an effective diameter L₂ of the second lens satisfies: 49 mm<L₂<56 mm.

Optionally, the polarizing reflective element has a transmission axis through which light passes, and the angle between the transmission axis of the polarizing reflective element and a fast or slow axis of the first phase retarder is 45°.

Optionally, the beam splitting element is a transflective film, and is provided on the fourth surface;
the first phase retarder is a quarter-wave plate, the polarizing reflective element is a polarizing reflective film, and the polarizing reflective element and the first phase retarder are laminated to form a first laminated film structure, which is provided on the second surface.

Optionally, the optical module further includes a display screen, which has a light-emitting surface for emitting incident light, and is located on one side of the second lens facing away from the first lens.

Optionally, the optical module further includes a second phase retarder and a polarizing element, wherein the polarizing element is located on one side of the display screen proximate to the light-emitting surface, and the second phase retarder is located between the beam splitting element and the polarizing element.

Optionally, the beam splitting element is located between the first phase retarder and the second phase retarder.

Optionally, the polarizing element is a linear polarizer, and an angle between a fast or slow axis direction of the second phase retarder and the transmission axis direction of the polarizing element is 45°.

Optionally, the polarizing element and the second phase retarder are laminated to form a second laminated film structure, which is provided on the light-emitting surface of the display screen.

According to another aspect of the present disclosure, a head mounted display is provided, which includes:
a housing; and
the above optical module.

The advantage of the present disclosure are as follows:

The embodiments of the present disclosure provide a design scheme for a folded optical path. By reasonably adjusting the edge thickness L₁ of the air gap between two lenses, it is possible to reduce the effective diameter of one of the lenses, thereby decreasing the overall weight and volume of the optical module. Moreover, when the edge thickness L₁ of the air gap between the two lenses in the optical module is adjusted to be within the range of 2 mm and 7 mm, the optical module may achieve both compactness and superior imaging quality.

Other features and advantages of the present disclosure will become clear by the following detailed description of exemplary embodiments of the present disclosure with reference to the accompanying drawings.

### BRIEF DESCRIPTION OF THE DRAWINGS

The accompanying drawings, which are incorporated in the description and constitute a part of the description, illustrate embodiments of the present disclosure and, together with the description thereof, serve to explain the principles of the present disclosure.

FIG. 1 shows a first schematic structural diagram of the optical module according to an embodiment of the present disclosure;

FIG. 2 shows a modulation transfer function (MTF) curve at 450 nm for the optical module according to an embodiment of the present disclosure;

FIG. 3 shows a modulation transfer function (MTF) curve at 540 nm for the optical module according to an embodiment of the present disclosure;

FIG. 4 shows a modulation transfer function (MTF) curve at 610 nm for the optical module according to an embodiment of the present disclosure;

FIG. 5 shows a second schematic structural diagram of the optical module according to an embodiment of the present disclosure;

FIG. 6 shows a third schematic structural diagram of the optical module according to an embodiment of the present disclosure;

FIG. 7 shows a first schematic diagram of the edge thickness of the air gap between two lenses of the optical module according to an embodiment of the present disclosure;

FIG. 8 shows a second schematic diagram of the edge thickness of the air gap between two lenses of the optical module according to an embodiment of the present disclosure;

FIG. 9 shows an enlarged partial diagram of FIG. 8.

### DESCRIPTION OF REFERENCE SIGNS

10, first lens; 11, first surface; 12, second surface; 20, second lens; 21, third surface; 22, fourth surface; 30, display screen; 40, polarizing reflective element; 50, first phase retarder; 60, beam splitting element; 70, optical axis; 80, polarizing element; 90, second phase retarder; 01, stop; 02, light.

### DETAILED DESCRIPTION

Various exemplary embodiments of the present disclosure will now be described in detail with reference to the accompanying drawings. It is to be noted that unless otherwise specified, the scope of present disclosure is not limited to relative arrangements, numerical expressions and values of components and steps as illustrated in the embodiments.

Description to at least one exemplary embodiment is for illustrative purpose only, and in no way implies any restriction on the present disclosure or application or use thereof.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Different values may be available for alternative examples of the exemplary embodiments.

It is to be noted that similar reference numbers and alphabetical letters represent similar items in the accompanying drawings. In the case that a certain item is identified in a drawing, further reference thereof may be omitted in the subsequent drawings.

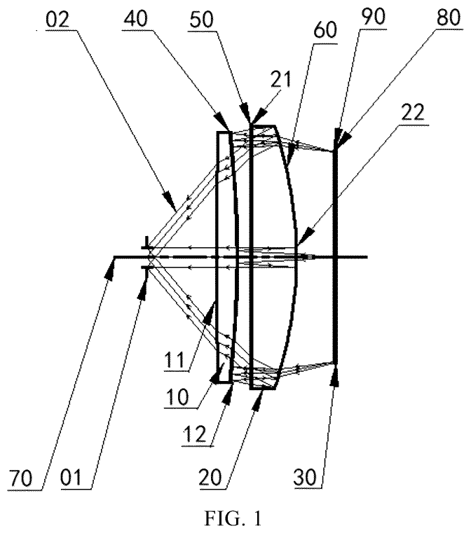

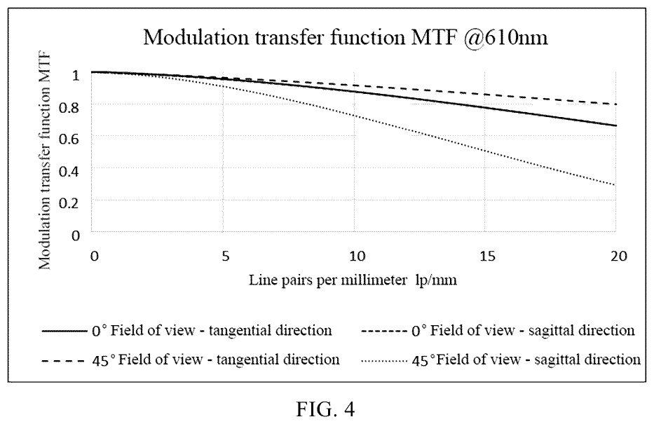

The optical module and the head mounted display provided by the embodiment of the present disclosure are described in detail below with reference to FIGS. 1 to 9.

According to an aspect of an embodiment of the present disclosure, an optical module is provided, which is designed in a folded optical path optical structure and may be suitably applied to a head mounted display (HMD), for example, VR smart glasses.

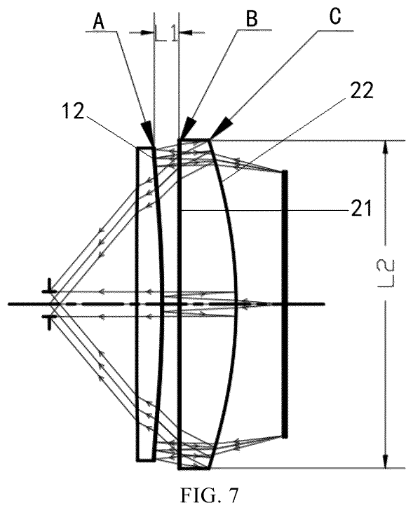

An embodiment of the present disclosure provides an optical module, and as shown in FIG. 1, the optical module comprises a first lens 10 and a second lens 20 sequentially along an optical axis 70 direction. As shown in FIG. 7, an edge thickness of an air gap between the first lens 10 and the second lens 20 is L₁, which satisfies: 2 mm<L₁<7 mm;
the optical module further comprises a polarizing reflective element 40, a first phase retarder 50, and a beam splitting element 60, wherein the polarizing reflective element 40 is located on either side of the first lens 10, the beam splitting element 60 is located on either side of the second lens 20, and the first phase retarder 50 is located between the polarizing reflective element 40 and the beam splitting element 60.

The optical module provided by the embodiment of the present disclosure may contain two optical lenses, namely the above first lens 10 and second lens 20. By minimizing the number of optical lenses, this design not only simplifies the assembly process but also contributes to a more compact and lightweight optical module.

As shown in FIG. 1, in the optical module provided by the embodiment of the present disclosure, the first lens 10 may be located proximate to the stop 01, while the second lens 20 may be located distal to the stop 01.

As shown in FIG. 7, in the optical module provided by the embodiment of the present disclosure, by adjusting the edge thickness L₁ of the air gap between the first lens 10 and the second lens 20 and keeping L₁ within a reasonable range, it is thus possible to appropriately reduce the effective diameter L₂ of the second lens 20, that is, the optical lens distal to the stop 01, and thus possible to reduce the size and weight of the second lens 20, which is conductive to reducing the overall volume and weight of the optical module, and moreover, may ensure that the optical module has excellent imaging quality under circumstances where the volume and weight of the optical module are reduced.

In the optical module provided by the present disclosure, the smaller the edge thickness L₁ of the air gap between the first lens 10 and the second lens 20, the smaller the effective diameter of the second lens 20 (the lens distal to the stop 01).

When the edge thickness L₁ of the air gap between the first lens 10 and the second lens 20 in the optical module is between 2.2 mm and 6.9 mm, the entire optical module not only possesses a smaller size and weight but also possesses excellent imaging quality.

For example, the edge thickness L₁ of the air gap between the first lens 10 and the second lens 20 may be 2.2 mm, 3.94 mm, or 6.9 mm.

Of course, the edge thickness L₁ of the air gap between the first lens 10 and the second lens 20 is not limited to the above three point values. Those skilled in the art can reasonably choose between 2.2 mm and 6.9 mm according to needs, thereby reasonably reducing the effective diameter of the second lens 20 in the optical module.

It should be noted that in existing related technologies, the size and weight of the optical module are typically adjusted by conventional methods such as adjusting the thickness of the lens or the thickness of the optical film. However, the solution provided by the embodiment of the present disclosure adopts a different approach. The solution provided by the embodiment of the present disclosure innovatively demonstrates that by adjusting the edge thickness value of the air gap between two lenses, it is possible to reduce the effective diameter of one of the lenses. Consequently, this method achieves significant reductions in the weight and volume of the optical module without adjusting the thickness of the lenses or the optical coatings, while maintaining high imaging quality. Thus, when the optical module is applied to the head mounted display, it is possible to make the overall weight of the head mounted display lighter, thereby improving wearing comfort of a user.

In addition to the two above optical lenses, the optical module provided by the present disclosure also includes the polarizing reflective element 40, the first phase retarder 50, and the beam splitting element 60, thereby forming a folded optical path.

The optical module provided by the present disclosure is a folded optical path structure. As shown in FIGS. 1, 5, and 6, the optical lenses and optical elements in the optical module may be arranged in a predetermined manner and located on the same optical axis 70. The entire optical path structure has a small size and does not occupy much space, and thus is very suitable for application in wearable devices, such as head mounted displays.

Here, the beam splitting element 60 is a transflective film, for example.

In the embodiments of the present disclosure, the beam splitting element 60 allows part of light to transmit and part of the light to be reflected.

It should be noted that the reflectivity of the beam splitting element 60 may be flexibly adjusted according to specific needs, which is not limited in the embodiment of the present disclosure.

Here, the polarizing reflective element 40 is a polarizing reflective film, for example.

In the embodiments of the present disclosure, the polarizing reflective element 40 is, for example, a polarizing reflective component that reflects horizontally linearly polarized light and transmits vertically linearly polarized light. Alternatively, the polarizing reflective element 40 may also be a polarizing reflective component that reflects a linearly polarized light at any specific angle and transmits a linearly polarized light perpendicular to that angle.

Here, the first phase retarder 50 is, for example, a quarter-wave plate or other phase delay plates.

The phase retarder may be used to alter the polarization state of light in the folded optical path structure. For instance, it is used to convert the linearly polarized light into a circularly polarized light or vice versa.

In the embodiments of the present disclosure, the first phase retarder 50 cooperates with the polarizing reflective element 40 to analyze and propagate the light.

The embodiments of the present disclosure provides a design scheme for a folded optical path, in which by reasonably adjusting the edge thickness L₁ of the air gap between two lenses in the optical path structure, it is possible to reduce the effective diameter of the lens distal to the stop 01, for example, which may reduce the size and weight of one lens in the optical path, and thus reduce the overall weight and volume of the optical module. When the edge thickness L₁ of the air gap between the two lenses is adjusted to be between 2 mm and 7 mm, the optical module may achieve good imaging quality.

In some examples of the present disclosure, as shown in FIGS. 1 and 7, the first lens includes a first surface 11 and a second surface 12, the second lens includes a third surface 21 and a fourth surface 22, wherein the second surface 12 and the third surface 21 are adjacent and spaced apart;
the edge thickness L₁ of the air gap between the first lens and the second lens is a distance along the optical axis 70 direction between a point A on the second surface 12 and a point B on the third surface 21, wherein the point A is an incident point at which an upper marginal ray in incident light at the maximum field angle of the optical module is incident on the second surface 12 for the first time, and the point B is an incident point at which the upper marginal ray is incident on the third surface 21 for the second time.

In the optical module provided by the embodiments of the present disclosure, the smaller the edge thickness L₁ of the air gap between the first lens 10 and the second lens 20 is, the smaller the effective diameter of the second lens 20 is. As shown in FIG. 7, L₁ may refer to the edge thickness of the air gap between the second surface 12 and the third surface 21.

In the embodiments of the present disclosure, as shown in FIG. 7, the effective diameter L₂ of the second lens 20 distal to the stop 01 is: twice the distance of the incident point C, at which light 02 at the upper margin at the maximum field angle of the optical module is incident on the fourth surface 22 of the second lens 20 for the first time, from the optical axis 70.

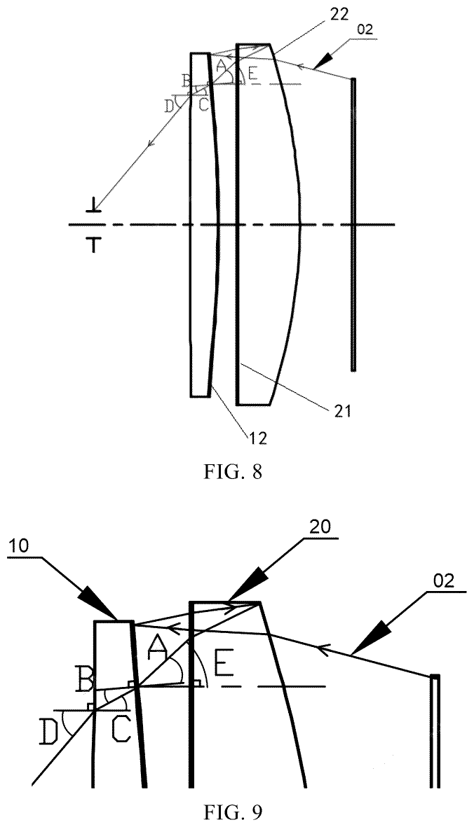

In the embodiments of the present disclosure, as shown in FIGS. 8 and 9, propagation of the light 02 on the surface (that is, the second surface 12) of the first lens 10 away from the stop 01 at the maximum field angle of the optical module satisfies refraction law, that is, n₁*sin(B)=sin(A); wherein n₁ is the refractive index of the first lens 10, B is the emergent angle of the light 02 on the surface (that is, the second surface 12) of the first lens 10 away from the stop 01 at the maximum field angle of the optical module, and A is the incident angle of the light 02 on the surface (that is, the second surface 12) of the first lens 10 away from the stop 01 at the maximum field angle of the optical module.

Please continue to refer to FIGS. 8 and 9, wherein FIG. 9 shows an enlarged partial diagram of FIG. 8. The light 02 on the surface (that is, the first surface 11) of the first lens 10 close to the stop 01 at the maximum field angle of the optical module also satisfies refraction law, that is, sin(D)=n₂*sin(C); wherein C is the incident angle of the light 02 on the surface (that is, the first surface 11) of the first lens 10 close to the stop 01 at the maximum field angle of the optical module, D is the emergent angle of the light 02 on the surface (that is, the first surface 11) of the first lens 10 close to the stop 01 at the maximum field angle of the optical module, and twice the angular value of D is the field angle of the optical module.

In the optical module of the embodiments of the present disclosure, a contour of an edge of the surface (that is, the second surface 12, or a rear surface) of the first lens 10 away from the stop 01 is a surface approximately perpendicular to the optical axis 70, so the angle a is positively correlated with the angle E, wherein the angle E is the angle between the optical axis 70 and the light 02 when the light 02 are incident on the first lens 10 for the second time at the maximum field of view of the optical module. The field angle of the optical module is positively correlated with the angle A, and thus the angle E is positively correlated with the field angle of the optical module.

Thus, when the field angle of the optical module is constant, the range of the angle E is basically determined and is approximately equal to the angle D, while the effective diameter L2 of the second lens 20 is positively correlated with the product of tan (E) and the edge thickness L₁ of the air gap between the two lenses. Therefore, the smaller the edge thickness L₁ of the air gap between the two lenses in the optical module, the smaller the effective diameter L₂ of the second lens 20 distal to the stop 01. When the edge thickness L₁ of the air gap between the first lens 10 and the second lens 20 is 2.2 to 6.9 mm, better image quality is achieved.

In some examples of the present disclosure, the effective diameter L₂ of the second lens 20 satisfies: 49 mm<L₂<56 mm.

That is to say, when the thickness L₁ of the air gap between the first lens 10 proximate to the stop 01 and the second lens 20 distal to the stop 01 in the optical module is 2.2 mm to 6.9 mm, the effective diameter L₂ of the second lens 20 may be adjusted to be 49 mm<L₂<56 mm.

For example, the effective diameter L₂ of the second lens 20 may satisfy: 49.1 mm≤L₂≤55.7 mm. At this time, it is possible to make the optical module light in weight while having good imaging quality.

In some examples of the present disclosure, the polarizing reflective element 40 has a transmission axis through which light passes, and the angle between the transmission axis of the polarizing reflective element 40 and a fast or slow axis of the first phase retarder 50 is 45°.

In the optical module of the embodiments of the present disclosure, the first phase retarder 50 is located on the same optical axis 70 as the polarizing reflective element 40, and moreover, the first phase retarder 50 needs to be located between the beam splitting element 60 and the polarizing reflective element 40, and the specific setting position thereof may be flexibly adjusted as required.

The polarizing reflective element 40 has the transmission axis, the angle between the transmission axis of the polarizing reflective element 40 and the fast axis of the first phase retarder 50 is set to be 45°, and the angle between the transmission axis of the polarizing reflective element 40 and the slow axis of the first phase retarder 50 is set to be −45°.

The polarizing reflective element 40 is, for example, a polarizing reflective component that reflects horizontally linearly polarized light and transmits vertically linearly polarized light. Alternatively, the polarizing reflective element 40 may also be a polarizing reflective component that reflects a linearly polarized light at any specific angle and transmits a linearly polarized light perpendicular to that angle.

The first phase retarder 50 is, for example, a quarter-wave plate or other phase delay plates, and may be used to alter the polarization state of light in the folded optical path structure. In the embodiments of the present disclosure, the first phase retarder 50 cooperates with the polarizing reflective element 40 to analyze and propagate the light.

The first phase retarder 50 has the fast axis and the slow axis. Here, the light in the same direction as the transmission axis of the polarizing reflective element 40 may transmit through the polarizing reflective element 40, and the light orthogonal to the transmission axis direction of the polarizing reflective element 40 cannot transmit through the polarizing reflective element 40.

Optionally, both the polarizing reflective element 40 and the first phase retarder 50 may be separate optical devices, although both can also be film structures.

In addition, the polarizing reflective element 40 and the first phase retarder 50 may be attached together, although both may also be arranged spaced apart, which is not limited in the embodiment of the present disclosure.

In some examples of the present disclosure, as shown in FIG. 1, the beam splitting element 60 is a transflective film, and is provided on the fourth surface 22; the first phase retarder 50 is a quarter-wave plate, the polarizing reflective element 40 is a polarizing reflective film, and the polarizing reflective element 40 and the first phase retarder 50 are laminated to form a first laminated film structure, which is provided on the second surface 12.

Here, the beam splitting element 60 is a transflective film, which can ensure that a part of the light is transmitted and a part of the light is reflected.

The beam splitting element 60 may be set up as a separate optical device set up in the optical path structure, or may be configured as a film structure attached to the fourth surface 22 of the second lens 20, which may be flexibly selected by those skilled in the art according to specific needs, and is not specifically limited herein.

Here, the second surface 12 on which the polarizing reflective element 40 and the first phase retarder 50 are provided may be any one of a flat surface, a spherical surface, an aspheric surface, a free-form surface, or a cylindrical surface.

That is to say, both the polarizing reflective element 40 and the first phase retarder 50 may form the laminated film structure, and may be provided on an optical element of a variety of contour (such as the first lens 10), thereby allowing the polarizing reflective element 40 and the first phase retarder 50 to effectively accommodate the location of the mounting surface.

By attaching the beam splitting element 60, the first phase retarder 50, and the polarizing reflective element 40 on the surfaces of different lenses, there is no need to independently provide the beam splitting element 60, the first phase retarder 50 and the polarizing reflective element 40 in the optical path structure, thereby reducing the assembly difficulty of the optical module and saving costs.

In some examples of the present disclosure, as shown in FIG. 1, the optical module further includes a display screen 30, which has a light-emitting surface for emitting incident light, and is located on one side of the second lens 20 facing away from the first lens 10.

The light-emitting surface of the display screen 30, for example, may be equipped with a protective film.

The light emitted from the display screen 30 may be linearly polarized, circularly polarized, or natural light, which is not limited in the embodiments of the present disclosure.

The display screen 30 may be either an emissive screen or a reflective screen.

The emissive screen includes, but is not limited to, a LCD, LED, OLED, Micro-OLED, and ULED. The reflective screen includes, but is not limited to, a DMD (Digital Micromirror Device).

In some examples of the present disclosure, as shown in FIG. 1, the optical module further includes a second phase retarder 90 and a polarizing element 80, wherein the polarizing element 80 is located on one side of the display screen 30 proximate to the light-emitting surface, and the second phase retarder 90 is located between the beam splitting element 60 and the polarizing element 80.

The polarizing element 80 may be, for example, a linear polarizing plate. The polarizing element 80 has a transmission axis through which light passes, and the direction of the transmission axis may be along the horizontal direction, the vertical direction, or any other direction.

The light emitted from the light-emitting surface of the display screen 30 may be converted into linearly polarized light when passing through the polarizing element 80.

The second phase retarder 90 and the polarizing element 80 may be designed to be adjacent to the light-emitting surface of the display screen 30.

In some examples of the present disclosure, as shown in FIG. 1, the beam splitting element 60 is located between the first phase retarder 50 and the second phase retarder 90.

The setting position of the beam splitting element 60 in the optical module is very flexible and can be adjusted according to actual needs.

In some examples of the present disclosure, as shown in FIG. 1, the polarizing element 80 is a linear polarizer, and an angle between the direction of the fast axis or the slow axis of the second phase retarder 90 and the direction of the transmission axis of the polarizing element 80 is 45°.

In the embodiments of the present disclosure, the second phase retarder 90 and the polarizing element 80 are arranged in this order along the propagation direction of the light emitted from the light-emitting surface of the display screen 30. The polarizing element 80 has a transmission axis, and the angle between the transmission axis of the polarizing element 80 and the fast axis of the second phase retarder 90 is 45°; the angle may be +45° or −45°.

The second phase retarder 90 has the fast axis and the slow axis. The light in the same direction as the transmission axis of the polarizing element 80 may transmit through the polarizing element 80, and the light perpendicular to the transmission axis direction of the polarizing element 80 cannot transmit through the polarizing element 80.

In some examples of the present disclosure, as shown in FIG. 1, the polarizing element 80 and the second phase retarder 90 are laminated to form a second laminated film structure, which is provided on the light-emitting surface of the display screen 30.

For example, the polarizing element 80 may be attached to the light-emitting surface of the display screen 30 (for example, attached to a side of the screen protection sheet facing away from the display screen) by an optical adhesive. The second phase retarder 90 may be attached to a side of the polarizing element 80 facing away from the light-emitting surface of the display screen 30 by the optical adhesive.

It should be noted that when the display screen 30 may directly emit the circularly polarized light, the designs of the polarizing element 80 and the second phase retarder 90 may be omitted in the optical module.

In addition, the polarizing element 80 and the second phase retarder 90 may be disposed spaced apart at an appropriate position on the light emergent side of the display screen 30.

For the optical module provided by the embodiment of the present disclosure, as shown in FIG. 1, the propagation process of the light is as follows:

The light emitted by the display screen 30 becomes horizontally linearly polarized light after passing through the polarizing element 80, then becomes left-handed or right-handed circularly polarized light after passing through the second phase retarder 90, and after passing through the beam splitting element 60 and the second lens 20, then becomes horizontally linearly polarized light after passing through the first phase retarder 50; it becomes the horizontally linearly polarized light after being reflected by the polarizing reflective element 40, then becomes left-handed or right-handed circularly polarized light after passing through the first phase retarder 50 and the second lens 20, the becomes the right-handed or left-handed circularly polarized light after being reflected by the beam splitting element 60, then becomes the vertically linearly polarized light after passing through the first lens 10, the second lens 20 and the first phase retarder 50 as well as the polarizing reflective element 40 again, and then enters the stop 01.

### First Embodiment

As shown in FIG. 1, the optical module includes a first lens 10 and a second lens 20 sequentially along an optical axis 70 direction, and as shown in FIG. 7, the edge thickness L₁ of the air gap between the first lens 10 and the second lens 20 is 3.94 mm;
wherein, the first lens 10 includes a first surface 11 and a second surface 12, the second lens 20 includes a third surface 21 and a fourth surface 22, wherein the second surface 12 and the third surface 21 are adjacent and spaced apart; the first lens 10 is located proximate to the stop 01, and the second lens 20 is located distal to the stop 01;
the optical module further includes a polarizing reflective element 40, a first phase retarder 50, and a beam splitting element 60; the beam splitting element 60 is a transflective film, and is provided on the fourth surface 22; the first phase retarder 50 is a quarter-wave plate, the polarizing reflective element 40 is a polarizing reflective film, and the polarizing reflective element 40 and the first phase retarder 50 are laminated to form a first laminated film structure, which is provided on the second surface 12;
the optical module further includes a display screen 30, which has a light-emitting surface for emitting incident light, and the second lens 20 is close to the display screen 30;
the optical module further includes a second phase retarder 90 and a polarizing element 80, and the polarizing element 80 and the second phase retarder 90 are laminated to form a second laminated film structure, which is provided on the light-emitting surface of the display screen 30.

In the optical module, the edge thickness L1 of the air gap between the first lens 10 and the second lens 20 is 3.94 mm, and the effective diameter L₂ of the second lens 20 is 52.4 mm.

Specific parameters of the optical module provided by the first embodiment are shown in Table 1.

### Table 1 the Structural Parameters Table of the Optical Module of the First Embodiment

TABLE 1
structural parameters table

| | | | | | Fourth- | Sixth- | Eighth- |
|---|---|---|---|---|---|---|---|
| | | | Thickness/ | | order | order | order |
| | | | Gap | Curvature | aspheric | aspheric | aspheric |
| Part | Material | Surface | mm | radius mm | coefficient | coefficient | coefficient |
| stop 01 | / | / | 14 | Inf | / | / | / |
| polarizing | / | front | 0.08 | −178.3 | / | / | / |
| reflective | | surface | | | | | |
| element 40 | | rear | 0 | −178.3 | / | / | / |
| | | surface | | | | | |
| first phase | / | front | 0.08 | Inf | / | / | / |
| retarder 50 | | surface | | | | | |
| | | rear | 0 | Inf | / | / | / |
| | | surface | | | | | |
| first lens 10 | K26R | front | 4.0 | −1132.7 | 9.99E−006 | −1.12E−007 | 6.56E−010 |
| | | surface | | | | | |
| | | rear | 2.6 | −178.3 | 4.59E−006 | −3.19E−008 | 1.12E−010 |
| | | surface | | | | | |
| second lens | APEL | front | 9.0 | Inf | / | / | / |
| 20 | | surface | | | | | |
| | | rear | 7.5 | −76.7 | 2.11E−006 | −6.60E−008 | 1.80E−010 |
| | | surface | | | | | |
| second phase | / | front | 0.08 | Inf | / | / | / |
| retarder 90 | | surface | | | | | |
| | | rear | 0 | Inf | / | / | / |
| | | surface | | | | | |
| polarizing | / | front | 0.08 | Inf | / | / | / |
| element 80 | | surface | | | | | |
| | | rear | 0 | Inf | / | / | / |
| | | surface | | | | | |
| screen | BK7 | front | 0.5 | Inf | / | / | / |
| protection | | surface | | | | | |
| sheet | | rear | 0 | Inf | / | / | / |
| | | surface | | | | | |
| display | / | front | 0 | Inf | / | / | / |
| screen 30 | | surface | | | | | |

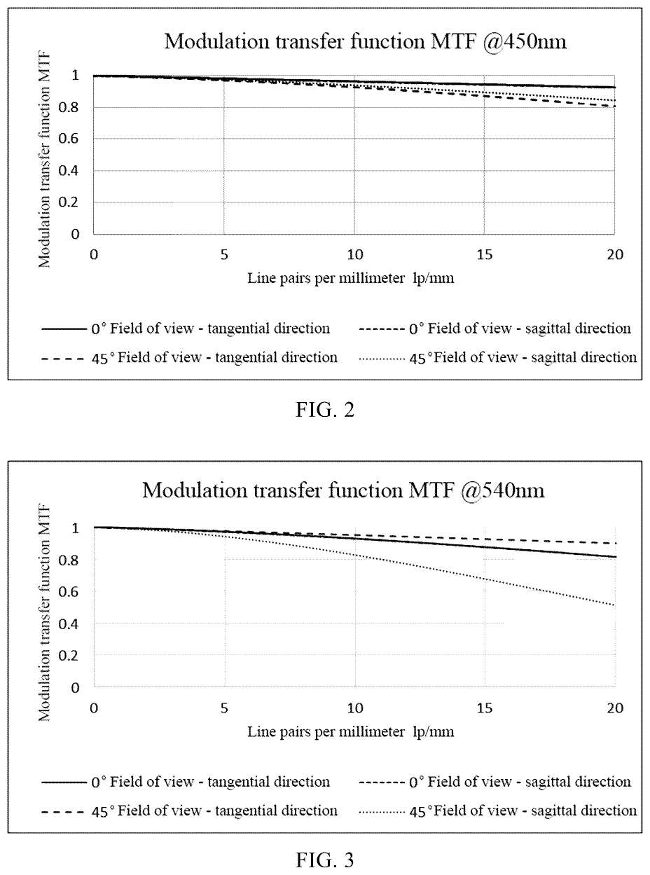

FIGS. 2, 3 and 4 respectively show modulation transfer function (MTF) curves of the optical module according to an embodiment of the present disclosure at 450 nm, 540 nm and 610 nm.

It can be seen from FIGS. 2 to 4 that: at 20 lp/mm spatial frequency:
the MTF value of optical module is higher than 0.8 at the wavelength of 450 nm, higher than 0.8 at the wavelength of 540 nm, and higher than 0.7 at the wavelength of 610 nm.

The optical module provided by the embodiment of the present disclosure may form a clear image.

### Second Embodiment

The structural parameters of the optical module provided by the second embodiment are shown in Table 2.

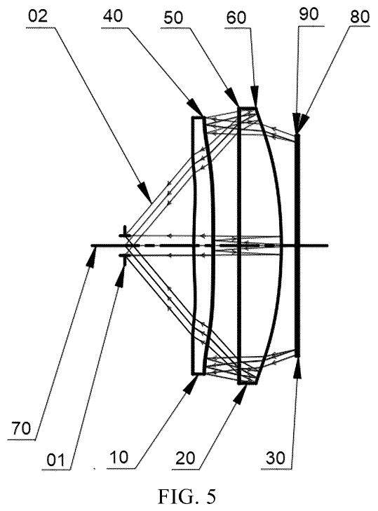

FIG. 5 shows the structure of the optical module, which is different from the first embodiment in that:

In the optical module, the edge thickness L₁ of the air gap between the first lens 10 and the second lens 20 is 6.9 mm, and the effective diameter L₂ of the second lens 20 is 55.7 mm.

TABLE 2
structural parameters table

| | | | | | Fourth- | Sixth- | Eighth- |
|---|---|---|---|---|---|---|---|
| | | | Thickness/ | | order | order | order |
| | | | Gap | Curvature | aspheric | aspheric | aspheric |
| Part | Material | Surface | mm | radius mm | coefficient | coefficient | coefficient |
| stop 01 | / | / | 14 | Inf | / | / | / |
| polarizing | / | front | 0.08 | −951.8 | / | / | / |
| reflective | | surface | | | | | |
| element 40 | | rear | 0 | −951.8 | / | / | / |
| | | surface | | | | | |
| first phase | / | front | 0.08 | Inf | / | / | / |
| retarder 50 | | surface | | | | | |
| | | rear | 0 | Inf | / | / | / |
| | | surface | | | | | |
| first lens | K26R | front | 6.0 | 117.6 | −7.61E−006 | −1.23E−007 | 6.38E−010 |
| 10 | | surface | | | | | |
| | | rear | 3.2 | −951.8 | −1.16E−006 | −4.51E−008 | 1.33E−010 |
| | | surface | | | | | |
| second | APEL | front | 9.0 | Inf | / | / | / |
| lens 20 | | surface | | | | | |
| | | rear | 0.5 | −89.9 | −3.37E−007 | −6.70E−009 | 1.74E−011 |
| | | surface | | | | | |
| second | / | front | 0.08 | Inf | / | / | / |
| phase | | surface | | | | | |
| retarder 90 | | rear | 0 | Inf | / | / | / |
| | | surface | | | | | |
| polarizing | / | front | 0.08 | Inf | / | / | / |
| element 80 | | surface | | | | | |
| | | rear | 0 | Inf | / | / | / |
| | | surface | | | | | |
| screen | BK7 | front | 0.34 | Inf | / | / | / |
| protection | | surface | | | | | |
| sheet | | rear | 0 | Inf | / | / | / |
| | | surface | | | | | |
| display | / | front | 0 | Inf | / | / | / |
| screen 30 | | surface | | | | | |

The MTF curves of the optical module provided by the second embodiment of the present disclosure at 450 nm, 540 nm, 610 nm, and 20 lp/mm spatial frequency are similar to the MTF curves shown in FIGS. 2 to 4. The optical module provided by the second embodiment may also form a clear image.

### Third Embodiment

The structural parameters of the optical module provided by the third embodiment are shown in Table 3.

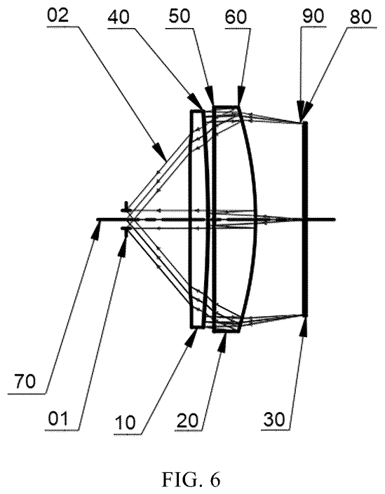

FIG. 6 shows the structure of the optical module, which is different from the first embodiment in that:

In the optical module, the edge thickness L₁ of the air gap between the first lens 10 and the second lens 20 is 2.2 mm, and the effective diameter L₂ of the second lens 20 is 49.1 mm.

TABLE 3
structural parameters table

| | | | | | Fourth- | Sixth- | Eighth- |
|---|---|---|---|---|---|---|---|
| | | | Thickness/ | | order | order | order |
| | | | Gap | Curvature | aspheric | aspheric | aspheric |
| Part | Material | Surface | mm | radius mm | coefficient | coefficient | coefficient |
| stop 01 | / | / | 14 | Inf | / | / | / |
| polarizing | / | front | 0.08 | −215.9 | / | / | / |
| reflective | | surface | | | | | |
| element 40 | | rear | 0 | −215.9 | / | / | / |
| | | surface | | | | | |
| first phase | / | front | 0.08 | Inf | / | / | / |
| retarder 50 | | surface | | | | | |
| | | rear | 0 | Inf | / | / | / |
| | | surface | | | | | |
| first lens | K26R | front | 3.9 | −685.32 | 1.08E−005 | −1.11E−007 | −2.02E−010 |
| 10 | | surface | | | | | |
| | | rear | 1.2 | −215.9 | 4.65E−006 | −3.21E−008 | −1.93E−010 |
| | | surface | | | | | |
| second | APEL | front | 9.0 | Inf | / | / | / |
| lens 20 | | surface | | | | | |
| | | rear | 10.6 | −77.0 | 2.13E−006 | −6.48E−009 | −1.92E−011 |
| | | surface | | | | | |
| second | / | front | 0.08 | Inf | / | / | / |
| phase | | surface | | | | | |
| retarder 90 | | rear | 0 | Inf | / | / | / |
| | | surface | | | | | |
| polarizing | / | front | 0.08 | Inf | / | / | / |
| element 80 | | surface | | | | | |
| | | rear | 0 | Inf | / | / | / |
| | | surface | | | | | |
| screen | BK7 | front | 0.5 | Inf | / | / | / |
| protection | | surface | | | | | |
| sheet | | rear | 0 | Inf | / | / | / |
| | | surface | | | | | |
| display | / | front | 0 | Inf | / | / | / |
| screen 30 | | surface | | | | | |

The MTF curves of the optical module provided by the third embodiment of the present disclosure at 450 nm, 540 nm, 610 nm, and 20 lp/mm spatial frequency are similar to the MTF curves shown in FIGS. 2 to 4. The optical module provided by the third embodiment may also form a clear image.

According to another aspect of an embodiment of the present disclosure, a head mounted display is provided, which includes a housing and above optical module.

The head mounted display is, for example, a VR head mounted device, including VR glasses or a VR helmet, which is not specifically limited in the embodiment of the present disclosure.

The specific implementation of the head mounted display in the embodiment of the present disclosure may refer to the embodiments of the above optical module, and therefore possesses at least all the beneficial effects brought by the technical solutions of the above embodiments, which will not be repeated herein.

The above embodiments focus on the differences between the various embodiments, and the different optimization features between the various embodiments, as long as they do not contradict each other, may be combined to form a better embodiment, which will not be repeated herein for the brevity of the text.

Although some specific embodiments of the present disclosure have been described in detail through examples, those skilled in the art should understand that the above examples are for illustration only and are not intended to limit the scope of the present disclosure. Those skilled in the art should understand that the above embodiments can be modified without departing from the scope and spirit of the present disclosure. The scope of the present disclosure is defined by the accompanying claims.

1. An optical module, comprising:
a first lens and a second lens positioned sequentially along an optical axis direction, an edge thickness of an air gap between the first lens and the second lens being L₁, which satisfies: 2 mm<L₁<7 mm;
a polarizing reflective element,
a first phase retarder, and
a beam splitting element,
wherein the polarizing reflective element is located on a side of the first lens, the beam splitting element is located on a side of the second lens, and the first phase retarder is located between the polarizing reflective element and the beam splitting element.

2. The optical module according to claim 1, wherein the first lens comprises a first surface and a second surface, the second lens comprises a third surface and a fourth surface, wherein the second surface and the third surface are adjacent and spaced apart;
the edge thickness L₁ of the air gap between the first lens and the second lens is a distance along the optical axis direction between a point A on the second surface and a point B on the third surface, wherein the point A is an incident point at which an upper marginal ray in incident light at the maximum field angle of the optical module is incident on the second surface for the first time, and the point B is an incident point at which the upper marginal ray is incident on the third surface for the second time.

3. The optical module according to claim 1, wherein an effective diameter L₂ of the second lens satisfies: 49 mm<L₂<56 mm.

4. The optical module according to claim 1, wherein the polarizing reflective element has a transmission axis through which light passes, and an angle between the transmission axis of the polarizing reflective element and a fast or slow axis of the first phase retarder is 45°.

5. The optical module according to claim 2, wherein the beam splitting element is a transflective film, and is provided on the fourth surface;
the first phase retarder is a quarter-wave plate, the polarizing reflective element is a polarizing reflective film, and the polarizing reflective element and the first phase retarder are laminated to form a first laminated film structure, which is provided on the second surface.

6. The optical module according to claim 1, further comprises a display screen, which has a light-emitting surface for emitting incident light, and is located on one side of the second lens facing away from the first lens.

7. The optical module according to claim 6, further comprises a second phase retarder and a polarizing element, wherein the polarizing element is located on one side of the display screen proximate to the light-emitting surface, and the second phase retarder is located between the beam splitting element and the polarizing element.

8. The optical module according to claim 7, wherein the beam splitting element is located between the first phase retarder and the second phase retarder.

9. The optical module according to claim 7, wherein the polarizing element is a linear polarizer, and an angle between a fast or slow axis direction of the second phase retarder and a transmission axis direction of the polarizing element is 45°.

10. The optical module according to claim 7, wherein the polarizing element and the second phase retarder are laminated to form a second laminated film structure, which is provided on the light-emitting surface of the display screen.

11. A head mounted display, comprising:
a housing; and
an optical module according to claim 1.
